(19) United States
(12) Patent Application Publication
(10) Pub. No.: US 2007/0039978 A1
(43) Pub. Date: Feb. 22, 2007

(54) Emptying device

(76) Inventor: Erich Scheugenpflug, Neustadt/Donau (DE)

Correspondence Address: HEAD, JOHNSON & KACHIGIAN, 228 W 17TH PLACE, TULSA, OK, 74119, US

(21) Appl. No.: 11/506,032

(22) Filed: Aug. 17, 2006

(30) Foreign Application Priority Data
Aug. 19, 2005 (DE) 102005039359.4
Oct. 18, 2005 (DE) 102005049805.1

(51) Int. Cl. G01F 13/00; B65D 88/54

(52) U.S. Cl. 222/252; 222/319

(57) ABSTRACT

For bubble free emptying of pasteous substances from drum-shaped containers these are pumped out through a drum follower plate placed onto the paste. In a refinement, the drum follower plate is provided hollow with a lower grid plate and before the beginning of the pumping out process through evacuation of the hollow intermediary space air, possibly present under the drum follower plate, is sucked from there into the intermediary space, so that the pump scooping from below the grid plate only feeds pasteous material right from the beginning.

### I. AREA OF APPLICATION

The invention regards an emptying device for highly viscous materials.

### II. TECHNICAL BACKGROUND

Materials that are so viscous that, due to gravity, they do not let enclosed air bubbles exit upwards—also in large containers—, or the material does not continue to slide to the deepest spot any more, pose considerable difficulties, when this highly viscous material is to be fed out of a container e.g. through a pipe connection, so that no air bubbles are fed in the feed line, since this may cause problems in a subsequent application, e.g. when automatically applying a line of sealant or glue material.

So far such pastes were transported and delivered in cylindrical buckets or drums, which were emptied by the user through pressing a so called drum follower plate onto the top surface of the paste with the drum opened, wherein a pump, e.g. a scoop piston pump was connected tight to a central pass through in the drum follower plate (drum follower pump).

Air bleeding hereby causes problems:

Especially through initially pressing on the follower plate, rises in the surface of the paste should be flattened and enclosed air, initially present between the surface of the paste and the plate shall be pressed out through the central opening or evacuated actively.

The design of the pump hereby is of minor importance. Instead of a scoop cone pump also eccentrical helix pumps and other kinds of pumps with respective specific advantages and disadvantages, in particular when feeding pasteous materials, can be used.

The disadvantage is, that between the plate and the surface of the paste, but also in the interior of the paste completely enclosed by it, air filled cavities can be present, which, due to lack of connection to the outlet opening in the plate, do not empty, and only reach the feed out line during the emptying process.

Further disadvantages consisted in, that:
the user always had to empty a part of the material, in which air enclosures were to be suspected, at the beginning of the emptying process,
due to the wrong setting of the contact pressure, the follower plate was pressed to the bottom in the material in the container, and the material was squeezed past the circumferential seal of the plate on the side, or
due to insufficient contact pressure the pump has fed air and therefore the undisturbed emptying of the containers strongly depended on the experience of the operator.

### III. DESCRIPTION OF THE INVENTION

a.) Technical Objective

It is therefore the objective of the invention to provide a emptying device and a evacuation process enabling a reliably bubble free, this means cavity free extraction of the paste, in spite of being constructed in a simple and cost effective manner.

b.) Solution

This solution is provided through the claims 1 and 33. Advantageous embodiments result from the dependent claims.

Through providing the drum follower plate with a tight upper plate and a lower grid plate connected to it, whose intermediary space can be evacuated, only through the openings between the grid plate and the closed upper plate, thus normally only the grid openings, a passage of air or paste can occur.

When the drum follower plate is placed onto the surface of the paste with the grid plate facing downward, preferably completely covering the surface and abutting to the interior circumference of the container in a sealing manner, the grid plate initially only contacts the rises in the uneven surface of the paste.

Thereby some air filled cavities at the bottom of the grid plate will be created, which are completely enclosed by paste in circumferential direction and therefore are defined against each other and separated from each other.

By loading the drum follower plate with force in feed direction downward, thus into the container, and/or by evacuating the space between the closed upper plate and the grid plate with a vacuum connector, the air in these cavities, which are connected, due to the multitude of grid openings, with the intermediary space between the upper plate and grid plate, it is pressed upward into the intermediary space, so that after a while paste enters into the intermediary space from all grid openings, which can also be optically controlled well with a transparent upper plate.

As soon as paste enters into the intermediary space upwards, which can easily be seen with a transparent upper plate, this process could be terminated, since then it is assured, that no air enclosures are present on the lower side of the grid plate, from where the paste is pumped out through the follower plate.

As a precautionary measure this is preferably continued, until the whole intermediary space is filled with paste, which can be controlled in a simple manner—through connecting clear sight hoses or sight tubes to one or several vacuum connectors of the drum follower plate—and paste is to be seen there.

This process is performed before each pumping of paste out of the container and is preferably continued during the pumping process and in particular during the whole emptying process of the container, even in moments when no pumping of paste is performed.

After emptying the container completely, the drum follower plate, whose intermediary space is at least partially filled with paste, is disposed of, together with the container, therefore the follower plate is made from plastic in an economical manner.

In order to enable or facilitate the described procedure, the upper plate and the grid plate are connected tight, glued in particular, or integrally made in one piece, on the one hand at the external peripheral rim, and on the other hand especially over a pump wall, typically surrounding the central pump opening in a tight manner, bridging the elevation differential between the upper plate and the grid plate, onto whose upper end the pump, or its suction tube is imposed, for which a connecting device for tight imposition and for longitudinally fixed connection, at least in feed direction downward is provided, in order to load the drum follower plate in feed direction through loading the pump or the suction tube in feed direction.

The outer rim of the drum follower plate thereby is elastic in radial direction, in order to attach to the interior circumference of the container in a tight manner, which has a constant, mostly round cross section along its extension from the top to the bottom.

The rim of the drum follower plate preferably is a circumferential rim protruding above the upper plate, expanding conically upwards and to the outside, whose elasticity is assured through the elastic properties of the plastic material, of which the drum follower plate and thereby also its rim are made.

In order to assure that possibly any initial air inclusion between the surface of the paste and the grid plate are connected with at least one of the grid openings, the number of the grid openings is as big as possible, in particular larger than 100, or larger than 500, or even larger than 1000 or 2000, and the distances of the grid openings from each other, this means the width of the rims in between are as small as possible, this means at the most 30 mm, better at the most 20 mm, or at the most 10 mm.

The grid openings can be dot shaped, e.g. circular grid openings, or also longitudinal, in particular radially slotted grid openings, since it is not detrimental, when the same grid opening is in connection with several separate air enclosures. In order to avoid that the paste, which has seeped through the grid openings into the intermediary space of the follower plate, there again forms air enclosures, before the sucked in paste exits from the vacuum connector or from another overflow of the drum follower plate into the viewing hose (which can also suck out remaining air enclosures below the grid plate in the container) additional measures can be provided:

On the one hand a vacuum loading could be performed from several locations, so that air enclosed in one location is evacuated, while paste is already present at the other vacuum connector.

Furthermore it is advantageous when the elevation differential between the upper plate and the grid plate is in increased towards the vacuum connector or towards the overflow, in order to avoid sealing between upper plate and grid plate, before all the air is evacuated from the intermediary space.

This way, with a vacuum connector located close to the central pump opening, the elevation differential of the upper plate relative to the grid plate could increase in a conical manner from the upper rim towards the vacuum orifice typically located close to the middle.

The grid plate itself hereby can be provided as straight, thus flat, or rise in itself in a conical manner from the rim towards the middle, in order to facilitate the advection of the paste to the pump opening through pressure onto the drum follower plate in feed direction, this means into the container downwards.

Since the drum follower plate cannot be reused together with the container after emptying the container, and thereby also the paste absorbed by the drum follower plate, its volume has to be kept as small as possible, and thereby also the free distance between the upper plate and the grid plate, which therefore should be less than 30 mm, in particular less than 20 mm or even less than 10 mm.

In order to increase the stability of the plate, in spite of it being made from plastic, the upper plate and the grid plate are ribbed between each other, also with vertical rims or other spacers supported against each other, wherein the rims extend preferably in a radial manner, whereby in particular they do not extend from the outer rim to the inner pump wall, transitioning into it, in order to establish a connection in circumferential direction between the otherwise developing single chambers, in particular next to the interior circumference, thus the pump wall.

In order to move the drum follower plate relative to the container, and in particular to be able to impart force into the container in feed direction, the emptying device also comprises a lifting device for lifting and also especially for lowering the container on the one hand, and the drum follower plate on the other hand, relative to each other.

For this purpose can, as up to now, the pump placed on the follower plate, be connected with the lifting device, and both can be moved in a vertical direction relative to a fixed point, this means a carrier frame, while the container is standing still.

Preferably however the container is placed onto a carrier plate, movable relative to the carrier frame, with the consequence, that the drum follower plate and the pump remain in place. This brings the advantage, that all lines running to the drum follower plate and to the pump are not exposed to any movement, and thereby the risk of them being damaged is reduced.

This is useful in particular, since a whole array of sensors and thereby also electrical wires to the sensors, are provided in addition to the known emptying devices, in order to be able to better control and automate the emptying process:

On the one hand an enclosing housing, in particular with a transparent door is part of the emptying device, on the one hand, in order to start the lifting device only with the door closed, thereby reducing the risk of injury, on the other hand also in order to actively control temperature and humidity in the interior of the tight housing according to the storage requirements of the paste with respect to these physical parameters.

In addition a force sensor is useful, in order to control the pressure of the drum follower plate into the paste, and also a sensor for detecting the feeding velocity or feeding power off the pump, which is preferably controlled from the user side according to momentary requirements anyhow, in order to be able to perform plausibility checks between the sensed feed volume on the one hand and the lowering of the drum follower plate on the other hand, since in case both do not agree, it means that the paste has e.g. been pressed past the outer rim of the follower plate and thereby the impact pressure was too high, or on the other hand insufficient following of the plate due to insufficient feed pressure has occurred.

For the same reason it is useful to constantly control the vacuum applied to the vacuum connector through a sensor, and possibly also the elevated pressure in the paste in the container, resulting from the impact pressure.

Also here the congruence with predetermined desired values can be controlled, wherein the determination of the desired values is performed depending on the viscosity of the paste, the design of the pump etc.

With respect to all parameters controlled through sensors, in case of too strong a deviation between desired values and actual values, or in case of a negative result of the plausibility comparisons, an alarm is given, leading to a manual check by an operator.

Since the emptying device has a control system, which besides moving the lifting device and possibly activating the vacuum, performs these comparisons, and possibly a storage unit for the measured values of the sensors and also the results of the comparisons, and/or a data port, the correct execution of the whole emptying process can be recorded and referenced or checked.

One of the advantages of the described emptying device is, that in the flow path of the paste above the drum follower plate no additional air bleed valve is required, but this feed line can pass through, which not only reduces cost but also removes a source of malfunction.

Though in principle the design of the pump used in this emptying device is of secondary importance, the design of the scoop piston pump for pasteous materials shall be discussed, wherein a mushroom shaped scoop piston is vertically moved back and forth and thereby stroke by stroke paste is removed from the container, this means from the area in or below the drum follower plate, and fed upwards.

Since the drum follower plate is used as a disposable part, at the beginning of the emptying process of each new container the pump tube or suction tube has to be placed onto the pump opening of the drum follower plate and connected with it in a tight manner. This can be performed before or after evacuating the intermediary space of the drum follower plate:

When the evacuation is performed before the placement, the evacuation will preferably be performed manually through connecting the vacuum source with the vacuum connection of the drum follower plate until it is visible through optical control, that paste passes through all grid openings of the grid plate or one waits until in all sight hoses, connected to the existing vacuum connectors paste becomes visible.

The sight hoses thereby are provided long enough so that the vacuum loading only has to be finished, when in the pump opening of the drum follower plate which is still open towards the upper side, paste reaches up to a predetermined minimum level, preferably to the upper wall of the pump opening.

In case the evacuation is automatically performed through the control system, it will preferably only be performed after placing the pump or the suction tube onto the pump opening, and especially in this case it has to be assured, that also in the suction tube above or below the scoop cone no air enclosure remains.

Preferably a scoop piston pump is controlled in a manner, so that when the pump is stopped, the scoop piston always stops in a defined parking position relative to the pump housing, so that it is possible to provide a vacuum connector also at the suction tube, preferably below and/or above this parking position, and to evacuate also this part of the suction tube when the drum follower plate is being evacuated.

In case the evacuation process has to be performed automatically, controlled by the control system, preferably also the necessary optical control, either the passing of paste through all grid openings of the grid plate and/or paste reaching predetermined locations in all sight hoses−is also automatically controlled through sensors located in this spot:

Since also the feed force of the drum follower plate into the container is controlled, among other things depending on the viscosity of the paste, and the resulting pressure onto the paste, e.g. depending on the magnitude of the friction of the rim of the drum follower plate relative to the container, a reliable centering, also effective during the ongoing emptying, of the drum follower plate relative of the container shall be assured:

On the one hand this is performed through an initial insertion of the container into a centering device on the stand plate, e.g. the insertion between two stop rims having an angle between each other, which for control purposes also can be provided with a limit switch or a pressure sensor.

Since, in case the walls of the container are not completely vertical, the centering can degrade with the drum follower plate moving downwards, preferably a perpendicular direction motion device has to be provided, allowing a repositioning in both directions perpendicular to vertical, between the container on the one hand, and the drum follower plate on the other hand, possibly through a floating stand plate and/or a drum follower plate movable in perpendicular direction, through e.g. making the carrier arm, which holds the pump and the suction tube movable in perpendicular direction and also the drum follower plate in moved along, since it is solidly connected with the pump or the suction tube in perpendicular direction.

### IV. EMBODIMENTS

Embodiments according to the invention are now described in exemplary manner. It is shown in:

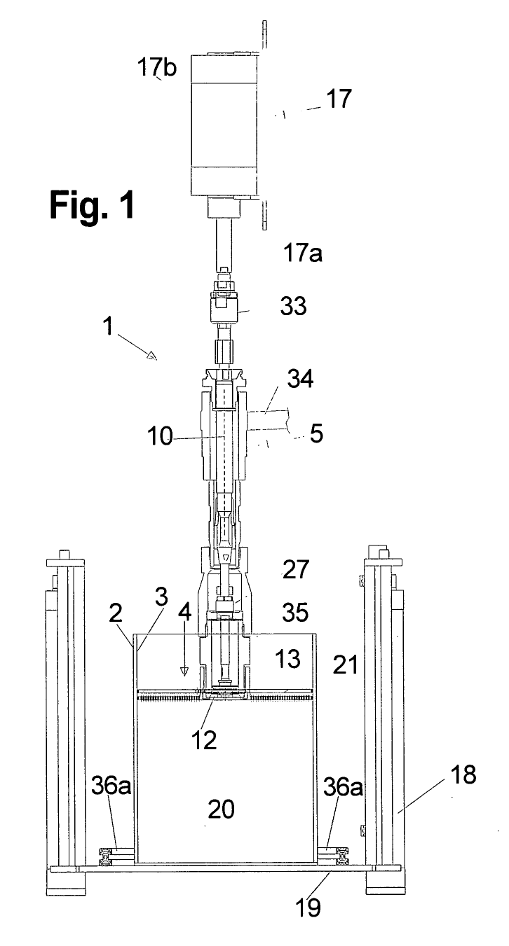

FIG. 1: A first embodiment of the emptying device,

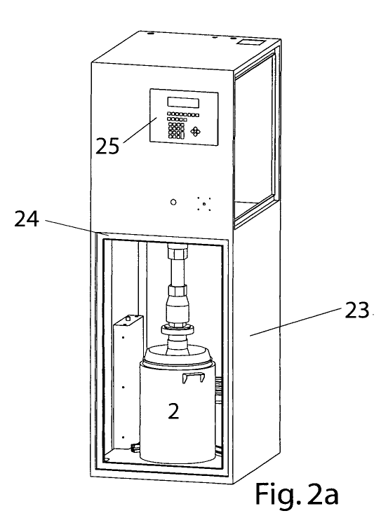

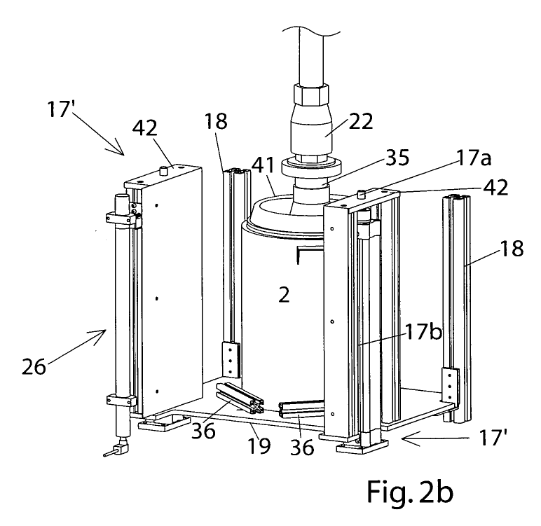

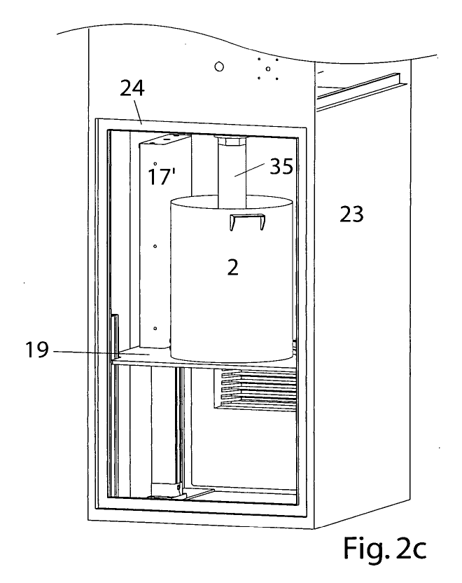

FIG. 2: A second embodiment of the emptying device,

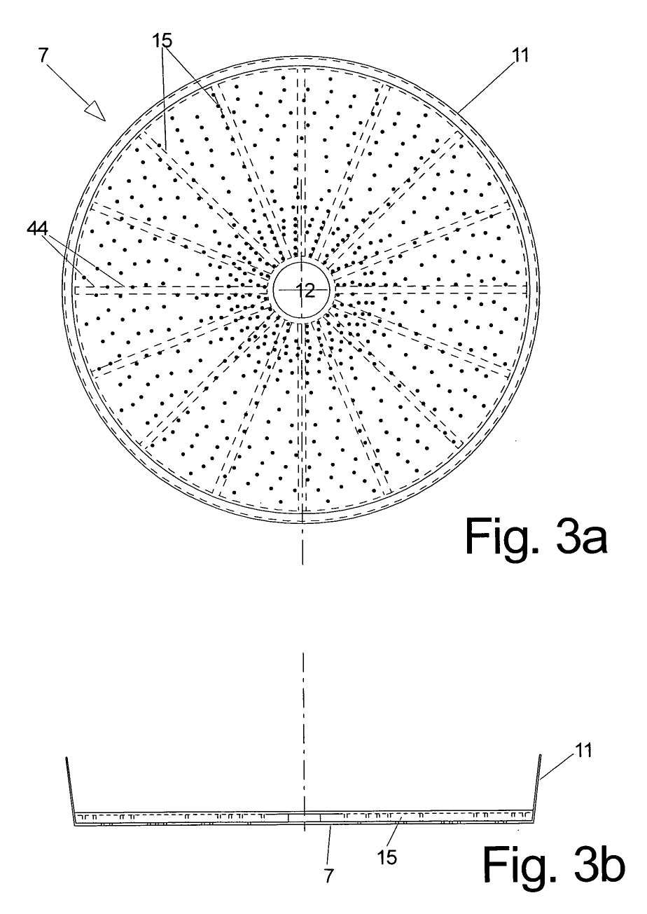

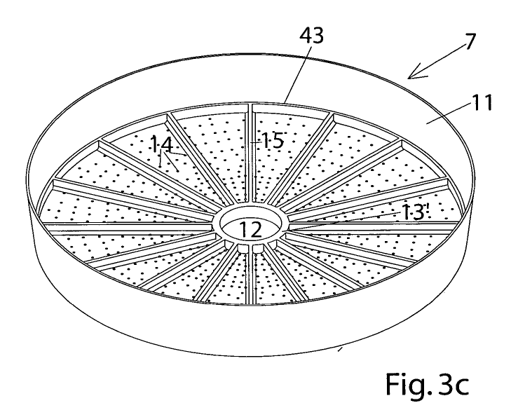

FIG. 3: The grid plate,

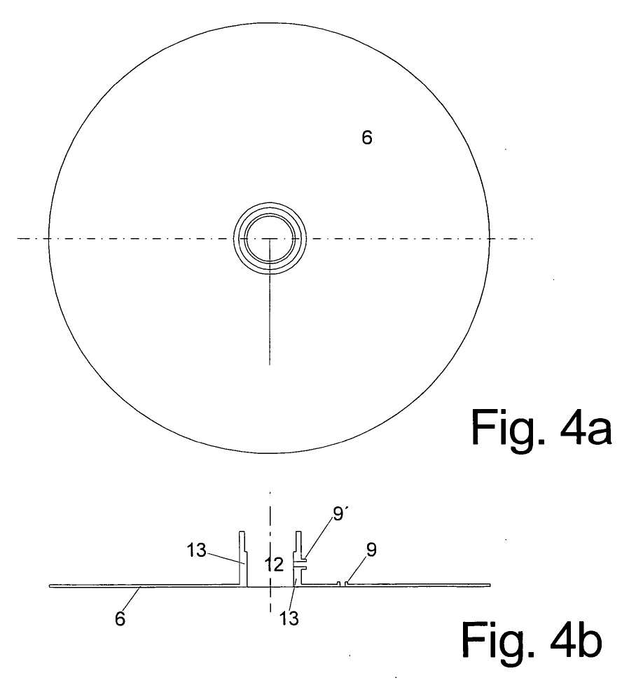

FIG. 4: The upper plate, and

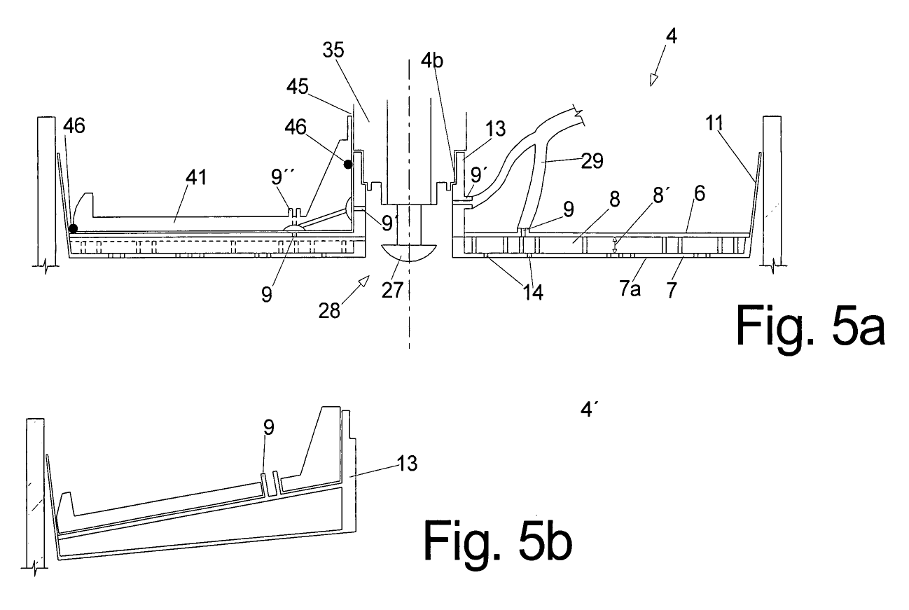

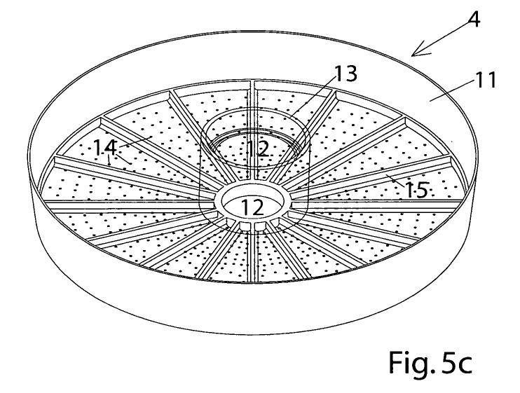

FIG. 5: The drum follower plate assembled from the above.

FIG. 1 shows the emptying device 1 in a side view, for removing paste 20, which is delivered in a barrel shaped container 2 with an interior cross section 3 constant over its height and mostly round.

For this purpose a drum follower plate 4 is placed or pressed onto the surface 21 of the paste 20, covering the whole surface 21 and abutting tight to the interior cross section 3 of the container 2.

Through a central pump opening 12 in the follower plate 4 the paste 20 is pumped out through a pump 5, whereby the volume of paste 20 in the container 2 decreases and the follower plate 4 follows the descending surface 21, due to pressurization in feed direction 10, thus in axial direction into the container 2.

The pump 5 in this case is a scoop piston pump, whose scoop piston 27 moves up and down in feed direction, in particular below the surface 21 of the paste 20 and thereby paste 20 is moved upward with each stroke into the suction tube 35 and from there further over the pump 5 and is transported through suitable extraction lines 34 to one or several connected users.

The follower plate 4, in particular its pump wall 13 protruding upward around the central pump opening 12 is tightly connected with the suction tube 35 of the pump 5, which sits on the pump wall 13, axially fixed in feed direction 10 and preferably also tight in perpendicular direction, being loaded with force in feed direction 10 through forward motion of the suction tube 35 and the pump 5, so that the paste 20 is displaced upward into the pump opening 12. In order to be able to move the pump 5 and the suction tube 35 in feed direction, both are connected via a coupling 33 with a lifting device 17 provided as a pneumatic piston, which is located above the pump 5 and the coupling 33 and whose piston rod 17a protrudes vertically downward out of the cylinder 17b, which is mounted to a housing or carrier frame in a solid manner.

In order to make the follower plate 4, which is positioned concentric with the motion axis of the piston rod 17a, exactly concentric with the container 2, before the positioning of the follower plate 4 the upwards open container 2 is placed onto the, in this case stationary stand plate 19, which is connected to a carrier frame 20 and pushed into a container centering device 36 perpendicular to the feed direction 10, consisting of two angled stop beams 36 positioned on the stand plate 19 in a defined manner, which have to be positioned depending on the used containers 2, in particular their outer diameter.

The drum follower plate 4 and further elements of the emptying device 1 are already equipped according to the invention according to FIG. 1, as described further below.

While in FIG. 1 the relative motion between the follower plate 4 and the container 2 is performed through lowering the follower plate 4 through moving the pump 5 and the suction tube 35 pressing on it, FIG. 2 show a solution, whereby in reverse, the follower plate 4 (which is not visible in FIG. 2 since it is inside container 2) as well as the connected pump 5 remain stationary, and instead the container 2 is moved upward against the feed direction 10 through vertical motion of the stand plate 19, on which the container 2, again inserted into a container centering device 36, is placed.

For this purpose the stand plate 19 is vertically guided along the vertical corner columns of the carrier frame 18 and movable through a lifting device 17′, comprising two pneumatic cylinders 17b attached onto opposing sides of the stand plate 19. In order not to lose any height, these are located in the corner areas of the square stand plate 19 and protrude from the lower end position of the stand plate 19 substantially upward, wherein the piston rod 17a extendable from the cylinder 17b presses against a bridge 42 extending above the cylinder 17b and connected with the stand plate 19.

Next to one of the lifting devices 17′ a distance measuring device 26 is located, which determines the elevation of the stand plate 19 at all times.

In FIG. 2 the load transfer from the suction tube 35 to the follower plate 4 is not performed directly, but through a stable pressure plate 41, generally made of metal, substantially covering the whole surface of the follower plate 4 from above, so that the follower plate 4 can be made as a disposable part from plastic with a relatively small internal stability and thereby inexpensive.

As FIGS. 2a and 2c are showing this emptying device 1 is located in an enclosed housing 23, shaped as a closet, whose front door 24, which is necessary for changing the container 2, has a sight window for optically controlling the correct emptying process. The housing 23, which is preferably created by tight plating of the stabilizing carrier frame 18, on the one hand provides protection against reaching into the emptying device during operation, which would pose the risk of injury through the parts moving relative to each other, and on the other hand, the ability to actively adjust and control the correct physical parameters like e.g. pressure, temperature, and humidity for the paste to be handled in the interior of the container 2, which is important in particular with pastes hardening through humidity and/or temperature as they are used for sealants and glues. In addition all functional parts of the emptying device, in particular the user interface for the electrical control 25 are housed, as well as all sensors necessary for controlling the emptying process, on the one hand sensors for the above listed physical parameters of the atmosphere within the container 2, on the other hand also a force sensor for the force loading of the container 2 and follower plate 4 against each other, and/or a pressure sensor for the pressure in the paste in the container 2 and/or in the suction tube 35 or the extraction line 34, prevailing in the paste 20.

Through controlling either the absolute values of these sensors and/or comparing the relative values, e.g. of the lifting velocity of the stand plate 19 relative to the pumping power of the pump, the control of the emptying process can be documented on the one hand and automatically controlled on the other hand besides the manual-optical control, which primarily comprises that paste can exit above the follower plate 4 and at the transitions between follower plate, suction tube 35, and pump 5.

The fixed mounting of the suction tube 35 and possibly of the pressure plate 41, as well as of the total assembly connected to it, as pump 5 and extraction lines 34 makes a movable design of all electrical wires and hoses for the media to be provided, running to these components, redundant and thereby considerably reduces the failure risk of the emptying device. The manufacturing effort to make the stand plate 19 and its control movable via a distance measuring device 26, are negligible in comparison.

In FIG. 3-5 the core piece of the emptying device according the invention, in particular the specially controlled drum follower plate 4, is explained:

As the vertical cut views of FIGS. 5a and b show, the drum follower plate 4 which is typically circular in a top view, is made in two layers from two injection molded plastic parts, which are connected tightly amongst each other, glued in particular:

On the one hand the lower grid plate 7 shown in FIG. 3, perforated by a multitude small round grid openings 14, distributed over the whole surface of the grid plate 7, as well as by a central large pump opening 12.

From the outer rim of the grid plate 7 a circumferential rim 11 protrudes upward, whose outer perimeter conically expands upward with a shallow slant angle of approximately 3°-10° relative to vertical, wherein the thickness of the material of the rim 11 is sized in a manner that the rim 11 with its freely extending upper end can attach itself elastically to the interior cross section 3 of the container 2.

The grid plate 13 is stiffened by star shaped stiffening ribs 15 located on its top surface, ending at the same elevation as a circumferential shoulder 43 in the interior circumference of the rim 11 and an annular enclosed pump wall 13′ surrounding the pump opening 12.

As especially FIG. 3a shows, the ribs 15 do not pass through in radial direction, but have pass through holes 44 between the areas separated from each other by the ribs, which were left out in the perspective drawing in FIG. 3c in order to simplify the illustration.

Onto to the shoulder 43 and onto the upper face surface of the pump wall 13′ subsequently a fitting upper plate 6 is placed and glued or welded, as shown in FIG. 4.

The upper plate 6 corresponds with its exterior diameter to the interior diameter of the rim 11 and is closed, besides an also present, equally sized central pump opening 12, from which a pump wall 13 protrudes upwards.

Through tight connection of the preferably clear upper plate 6 with the grid plate 7, the drum follower plate 4 or 4′ is created, which is shown in a longitudinal cut view in FIGS. 5a and b, here from the variant according to FIG. 5a is shown in a three dimensional view in FIG. 5c.

As FIG. 4 shows, the enclosed intermediary space 8 with the distance 8′ between the plates, thus created between the upper plate 6 and the grid plate 7, through at least one spout shaped vacuum connector 9 protruding from the upper plate 6. In addition the pump opening 12 in the area of the pump wall 13 can also have an opening through a vacuum connection 9′, open towards the side.

Thus, when the follower plate 4, placed onto the surface 21 of the paste 20 tightly abuts to the interior circumference of the container 2 with its rim 11 and the pump opening 12 is tightly closed through the imposed suction tube 35 and the connected pump 5, or closed tight by another means, through applying vacuum at the vacuum connector 9 on the one hand initially the air enclosed below the follower plate 4 can be evacuated and thereby the surface of the paste 20 flattened, which is successfully completed when paste 20 enters through all grid openings 14 into the intermediary space 8.

Through further vacuum application the intermediary space 8 is completely filled with paste, since as well as the grid openings 14, also the pass through holes 44 in the ribs 15 are sized sufficiently large for passing through the paste 20 with the applied vacuum.

The latest, when the whole intermediary space 8 is filled with paste 20, the paste 20 will also exit out of the vacuum connector 9 into a connected sight hose 29, which is preferably transparent like the upper plate 6 and which is used as a disposable part together with the follower plate 4.

As FIG. 5a shows, the grid plate 7 and the upper plate 6 can be provided as flat, thereby also the lower side 7a of the grid plate 7 can form a flat surface.

FIG. 5b, on the other hand shows an embodiment, wherein on the one hand the grid plate 7, and thereby also its bottom surface slightly rises from the outer rim towards the middle in a conical manner, preferably at an angle of 5°-15°. Hereby the displacement of the paste 20 in the container 2 towards the middle pump opening 12 is supported.

In addition and/or instead the distance 8′ between the upper plate 6 and the grid plate 7 can also be varied and increases in one direction, e.g. from the outer rim to the central pump wall 13 or versa, and the vacuum connector 9 can thereby be located in the area of the largest distance 8′.

Thereby it is avoided, that paste exists from the vacuum connector 9, before the intermediary space 8 is completely filled with paste, which minimizes the risk of air enclosures remaining below the follower plate 4.

In addition the FIG. 5, on their left side, show the loading of the follower plate 4 in feed direction 10 through the suction tube 35, via the pressure plate 41, which—formed as a turned part, made from metal, aluminum in particular—covers and loads substantially the whole upper surface of the follower plate 4, so that the follower plate itself can be manufactured with less internal stability.

In order to keep the vacuum connectors 9 or 9′ of the follower plate 4, protruding upwards in direction of the pressure plate 21, accessible, pass through holes are left open at the respective locations of the pressure plate 41, preferably extending around the center of the pressure plate 41 over a large angular area in kidney shape, in order not to have to maintain an exact rotating position between the pressure plate 41 and the follower plate 4. The pressure plate 41 is preferably connected to the suction tube 35 via a thread 45 in a solid manner.

Instead of connecting the vacuum connector 9, 9′ of the follower plate 4 through the pressure plate 41, it is also possible to seal the pressure plate 41 e.g. via circumferential seals at the interior circumference and the outer circumference of the pressure plate like e.g. O-rings 46, relative to the upper side of the follower plate 4, and to provide the pressure plate 41 itself with a vacuum connector 9″, connected with respective grooves in the lower side or the interior side of the pressure plate 41, corresponding to the vacuum connector 9 and 9′ of the follower plate 4.

This facilitates the placement of the pressure plate 41 onto the follower plate 4 and the application of vacuum, but has the disadvantage, that in case of sucking paste 20 into the vacuum connector 9″ of the pressure plate 41, this reusable pressure plate 41 has to be cleaned in a time consuming manner, and in addition there are no further sight controls possible for the filling of the total intermediary space 8 through paste 20.

FIG. 5a furthermore shows the scoop piston 27, when using a scoop piston pump as pump 5, moving up and down within the pump opening 12, resting in a parking position 28, which it generally occupies when the pump stands still.

If the scoop piston 27 is designed, so that—at least in its parking position 28—it can tightly abut to the interior circumference of the pump wall 13, also through the means of paste 20 adhering to the piston 27—preferably also in the pump wall 13, thus at a location above the scoop piston 27, located in its parking position 28, a vacuum connector has to be provided, in order to be able to remove air present at this location at the beginning of the emptying process.

The vacuum connector 9, 9′ can be connected, via a Y-shaped sight hose of sufficient length, with the same vacuum source. A sufficient length of the sight hoses is necessary in order to avoid that in one branch of the sight hose no paste 20 is visible yet, while the other branch is filled with paste 20 to an extent, that it is about to contaminate the fixed vacuum connector following behind the sight hose 29.

Furthermore in FIG. 5 the shoulder 43′ at the interior circumference of the pump wall 13 is visible, which serves to attach the suction tube 35 in a form tight manner in perpendicular direction.

### REFERENCE NUMERALS

1 Emptying device
2 Container
3 Interior cross section
4 Drum follower plate
5 Pump
6 Upper plate
7 Grid plate
7a Bottom side
8 Intermediary space
8′ Distance
9, 9′ Vacuum connector
10 Feed direction
11 Rim
12 Pump opening
13 Pump wall
14 Grid opening
15 Rib
16 Connection device
17, 17′ Lifting device
17a Piston rod
17b Cylinder
18 Carrier frame
19 Stand plate
20 Paste
21 Surface
22 Vacuum bell
23 Housing
24 Door
25 Control system
26 Distance measuring device
27 Scoop piston
28 Parking position
29 Sight hose
30 Vacuum sensor
31 Force sensor
32 Velocity sensor
33 Coupling
34 Extraction line
35 Suction tube
36 Container centering device
36a, b Ridge
37 Temperature sensor
38 Humidity sensor
39 Storage unit
40 Perpendicular motion device
41 Pressure plate
42 Ridge
43, 43′ Shoulder
44 Pass through
45 Thread
46 O-ring

1. An emptying device (1) for emptying pastes (20) out of drum shaped containers (2) with
a drum follower plate (4)
a pump (5) connected to the pump opening (12) of the drum follower plate (4),
characterized in, that
the drum follower plate (4) comprises an upper plate (6) and a lower grid plate (7), located closely to it, whose intermediary space (8) comprises a first vacuum connector (9).

2. An emptying device according to claim 1,
characterized in, that
the upper plate (6) is tightly connected with the grid plate (7), in particular glued, or integrally made with it in one piece.

3. An emptying device according to one of the preceding claims,
characterized in, that
the pump opening (12) is tightly separated from the intermediary space (8) through a pump wall (13).

4. An emptying device according to one of the preceding claims,
characterized in, that
the drum follower plate (4) comprises an outer rim (11), elastic in a radial direction, in particular a rim (11) protruding upward above the upper plate (6), conically expanding upward, in particular surrounding in an annular manner.

5. An emptying device according to one of the preceding claims,
characterized in, that
the grid openings (14) are separated from each other through rims with a maximum width of 30 millimeters, in particular with a maximum of 20 millimeters, in particular with a maximum of 10 millimeters.

6. An emptying device according to one of the preceding claims,
characterized in, that
the number of grid openings (14) is higher than 100, in particular higher than 500, in particular higher than 1000, in particular higher than 2000.

7. An emptying device according to one of the preceding claims,
characterized in, that
the grid openings (14) are longitudinal, in particular radially extending grid openings or dot shaped, in particular round grid openings (14), and in particular all grid openings (14) have the same shape.

8. An emptying device according to one of the preceding claims,
characterized in, that
the elevation difference between the upper plate (6) and the grid plate (7) is a free distance (8′) of the less than 30 millimeters, in particular less than 20 millimeters, in particular less than 10 millimeters.

9. An emptying device according to one of the preceding claims,
characterized in, that
between the upper plate (6) and the grid plate (7) vertically extending rims (15) are provided, in particular radially extending between the pump wall (13) and the outer wall (11), supporting and stabilizing the upper plate (6) versus the grid plate (7).

10. An emptying device according to one of the preceding claims,
characterized in, that
the drum follower plate (4) is made from plastic.

11. An emptying device according to one of the preceding claims,
characterized in, that
the upper plate (6) comprises a distance relative to the grid plate (7), changing in radial direction, in particular increasing from the outside towards the inside, and the at least one vacuum connector (9) is located in the area of the largest distance (8′).

12. An emptying device according to one of the preceding claims,
characterized in, that
the rims (15) extend radially and in particular in the radial area of the largest distance between the upper plate (6) and the grid plate (7) and do not reach the circumferential rim (11) or the pump wall (13).

13. An emptying device according to one of the preceding claims,
characterized in, that
the bottom side (7a) of the grid plate (7) rises from the outer rim towards the pump opening (12), in particular located in the center, in a slightly conical manner.

14. An emptying device according to one of the preceding claims,
characterized in, that
the drum follower plate (4), in particular its pump wall (13) comprises a connecting device (16) for longitudinally connecting with the pump (5) in a at least one direction.

15. An emptying device according to one of the preceding claims,
characterized in, that
the emptying device (1) comprises a lifting device (17) for raising and lowering the emptying device (1) relative to a fixed point, in particular a carrier frame (18).

16. An emptying device according to one of the preceding claims,
characterized in, that
the emptying device (1) comprises a lifting device (17′) for lifting the stand plate (19), on which the container (2) stands, relative to a carrier frame (18).

17. An emptying device according to one of the preceding claims,
characterized in, that
the emptying device (1) comprises an enclosed housing (23) with a in particular transparent door (24), wherein the lifting device (17, 17′), the drum follower plate (4) and the pump (5) and possibly a control system (25) are located.

18. An emptying device according to one of the preceding claims,
characterized in, that
the lifting device (17, 17′) comprises a distance measuring device or a position measuring device (26).

19. An emptying device according to one of the preceding claims,
characterized in, that
the drum follower plate (4) comprises at least a second vacuum connector (9′) within the pump wall (13).

20. An emptying device according to one of the preceding claims, wherein the pump (5) is a scoop piston pump,
characterized in, that
the second vacuum connector (9′) is located above the parking position (28) for the scoop piston (27) in the pump wall (13).

21. An emptying device according to one of the preceding claims,
characterized in, that
the vacuum connectors (9, 9′) are connected amongst each other.

22. An emptying device according to one of the preceding claims,
characterized in, that
from each vacuum connector (9, 9′) a transparent sight hose or a sight tube (29) extends.

23. An emptying device according to one of the preceding claims,
characterized in, that
a vacuum sensor (30) is connected with the vacuum connector (9,9′) and in particular located in the intermediary space (8).

24. An emptying device according to one of the preceding claims,
characterized in, that
a force sensor (31) is connected with the lifting device (17, 17′), measuring the force of the drum follower plate (4) pressing the paste (20).

25. An emptying device according to one of the preceding claims,
characterized in, that
a velocity sensor (32) is connected with the pump (5) measuring its feeding velocity.

26. An emptying device according to one of the preceding claims,
characterized in, that
all sensors are connected with the control system (25).

27. An emptying device according to one of the preceding claims,
characterized in, that
the control system (25) is capable to adapt the feed volume to the consumption of one or several simultaneously connected users.

28. An emptying device according to one of the preceding claims,
characterized in, that
between the lifting device (17) and the pump (5) a coupling (33) is located, that can be decoupled.

29. An emptying device according to one of the preceding claims,
characterized in, that
the extraction line (34) passes above, thus downstream of the pump (5) and in particular does not comprise a bleed air valve.

30. An emptying device according to one of the preceding claims,
characterized in, that
the stand plate (19) for the container (2) comprises a container centering device (36), in particular shaped as rearward stop rims (36a, b), angulated relative to each other.

31. An emptying device according to one of the preceding claims,
characterized in, that
the emptying device (1) comprises a temperature sensor (37) and/or a humidity sensor (38) within the housing (23).

32. An emptying device according to one of the preceding claims,
characterized in, that
the control system (25) comprises a data output and/or a storage unit for the data from the sensors comprised by the emptying device.

33. A process for emptying pastes from drum shaped containers (2) with a cross section (3) constant over their heights, wherein
a fitting drum follower plate (4) is placed onto the surface (21) of the paste (20),
paste (20) is pumped out through the drum follower plate (4), and
the drum follower plate (4) is fed after the descending surface (21),
characterized in, that
before pumping out, a percentage as large as possible, in particular the whole surface (21) of the paste (20), is brought in contact with the grid plate comprising a multitude of grid openings (14),
the side of the grid plate (7) facing away from the paste (20) is loaded with vacuum until, from as many as possible, preferably all grid openings (14) paste seeps out.

34. A process according to one of the preceding process claims,
characterized in, that
the vacuum loading occurs before each pumping process and it is maintained during the pumping process of and in particular the vacuum loading is continuous.

35. A process according to one of the preceding process claims,
characterized in, that
after completely emptying the container (2) the drum follower plate (4) is disposed of with the container (2).

36. A process according to one of the preceding process claims,
characterized in, that
the drum follower plate (4) is additionally loaded with a force in feed direction (10) into the container (2).

37. A process according to one of the preceding process claims,
characterized in, that
a perpendicular drive device (40) in at least two perpendicular directions relative to the feed direction (10) is either integrated into the stand plate (19) or into a carrier arm for the drum follower plate (4).

38. A process according to one of the preceding process claims,
characterized in, that
the vacuum loading is begun at several locations on the surface (21) simultaneously.

39. A process according to one of the preceding process claims,
characterized in, that
the vacuum loading is terminated, when a predetermined vacuum is reached and/or in the sight hoses (29), which are connected to each vacuum connector (9, 9′), paste (20) becomes visible.

40. A process according to one of the preceding process claims,
characterized in, that
before the beginning of the pumping process the pump (5) is brought in contact with the paste (20) through the drum follower plate (4).

41. A process according to one of the preceding process claims,
characterized in, that
the velocity of the pump, sucking through the drum follower plate (4), is controlled, in particular depending on the materials requirements of the one or several consumer(s) supplied by the pump (5).

42. A process according to one of the preceding process claims,
characterized in, that
the feeding force of the drum follower plate (4) against the container (2) is controlled, in particular depending on the viscosity of the paste (20) and/or the feed velocity of the pump (5), the position of the follower plate (4) in the container (2), the pressure in the container (2) measured in the paste (20) and/or the vacuum measured in the cavities.

43. A process according to one of the preceding process claims,
characterized in, that
the relative motion of the drum follower plate (4) and/or the pump (5) or its suction snorkel are supervised and controlled in their relative position.

44. A process according to one of the preceding process claims,
characterized in, that
before the pumping process the filled container (2) is opened and inserted into a container centering device (36),
the drum follower plate (4) placed onto the surface (21) is connected with a vacuum source, until in the sight hoses (29) and/or at the upper end of the pump wall (13), paste stands,
the vacuum loading is terminated, and
the pump (5) or a suction tube are placed onto the pump opening (12) in a tight manner and the pumping process is begun.

45. A process according to one of the preceding process claims,
characterized in, that
before the pump out process the drum follower plate (4) is loaded with pressure in feed direction (10) manually, in particular.

46. A process according to one of the preceding process claims,
characterized in, that
during the emptying process of the container (2) the temperature, the humidity, and in addition the force in feed direction (10) and the pressure or vacuum in the container (2) in or close to the paste (20) are measured and compared to the predetermined desired values and recorded.

47. A process according to one of the preceding process claims,
characterized in, that
in case of too strong a deviation of the desired values from the actual values of these sensors an alarm is given and a manual check through the operator is performed.

48. A process according to one of the preceding process claims,
characterized in, that
when using a scoop piston pump as pump (5) the scoop piston (27) assumes a predetermined parking position upon standstill of the pump and vacuum loading occurs, in particular before the first pumping of paste, also above, thus downstream of the scoop piston (27).

49. A process according to one of the preceding process claims,
characterized in, that
the connection between the pump (5) or the suction tube and the drum follower plate (4) is established through superimposing a vacuum bell (22), at least over a part of the drum follower plate (4) in particular its pump opening (12) and/or its vacuum connectors (9, 9′) and subsequent evacuation of the drum follower plate (4) through evacuation of the vacuum bell (22).

50. A process according to one of the preceding process claims,
characterized in, that
a self guiding centering of the drum follower plate (4) occurs through its conical shape relative to the container (2) during the emptying process.
